(19) United States
(12) Patent Application Publication
(10) Pub. No.: US 2011/0007954 A1
(43) Pub. Date: Jan. 13, 2011

(54) Method and System for Database-Guided Lesion Detection and Assessment

(75) Inventors: Michael Suehling, Plainsboro, NJ (US); Grzegorz Soza, Nurnberg (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignees: Siemens Corporation, Iselin, NJ (US); Siemens Aktiengesellschaft, Munich (DE)

(21) Appl. No.: 12/831,392

(22) Filed: Jul. 7, 2010

Related U.S. Application Data
(60) Provisional application No. 61/223,488, filed on Jul. 7, 2009.

(51) Int. Cl. G06K 9/00

(52) U.S. Cl. 382/128

(57) ABSTRACT

A method and system for automatically detecting lesions in a 3D medical image, such as a CT image or an MR image, is disclosed. Body parts are detected in the 3D medical image. Anatomical landmarks, organs, and bone structures are detected in the 3D medical image based on the detected body parts. Search regions are defined in the 3D medical image based on the detected anatomical landmarks, organs, and bone structures. Lesions are detected in each search region using a trained region-specific lesion detector.

This application claims the benefit of U.S. Provisional Application No. 61/224,488, filed Jul. 7, 2009, the disclosure of which is herein incorporated by reference.

### BACKGROUND OF THE INVENTION

The present invention relates to lesion detection in 3D medical images, and more particularly, to automatic database-guided lesion detection in medical images, such as computed tomography (CT) and magnetic resonance (MR) images.

Tumor staging and follow-up examinations account for a large portion of routine work in radiology. Cancer patients are typically subjected to examinations using medical imaging, such as CT, MR, or positron emission tomography (PET)/CT imaging, in regular intervals of several weeks or months in order to monitor patient status or assess responses to ongoing therapy. In such examinations, a radiologist typically checks whether tumors have changed in size, position, or form, and whether there are new lesions. However, conventional clinical practice exhibits a number of limitations.

According to current clinical guidelines, such as RECIST (Response Evaluation Criteria in Solid Tumors) and WHO (World Health Organization) guidelines, only the size of a few selected target lesions is tracked and reported over time. New lesions need to be mentioned, but the size of the new lesions does not need to be reported. The restriction to only a subset of target lesions in mainly due to the fact that manual assessment and size measurement of all lesions is very time consuming, especially if a patient has many lesions. Conventionally, lesion size is only measured in the form of one or two diameters. Recently, algorithms have been developed for lesion segmentation that provide volumetric size measurements for lesions. However, when started manually, a user typically must wait several seconds for such algorithms to run on each lesion. This makes the routine use of such segmentation algorithms impracticable. Also, since lesions may appear at many different parts in the body, including at bone structures and lymph nodes, lesions may be overlooked using manually detection of lesions.

Accordingly, an automatic method for detection lesions in different parts of the body is desirable.

### BRIEF SUMMARY OF THE INVENTION

The present invention provides a method and system for automatic detection of lesions in 3D medical images. Embodiments of the present invention detect lesions throughout the body, including in lymph nodes, organs, other soft tissues, and bone. Embodiments of the present invention utilize a probabilistic database-guided framework for lesion detection. In particular, embodiments of the present invention utilize a probabilistic framework for detection of lesion-specific search regions and a probabilistic framework for detection of lesions within the search regions. Embodiments of the present invention provide visualization and navigation of the results of the automatic lesion detection, and further embodiments of the present invention provide a clinical workflow that integrates the automatic lesion detection.

In one embodiment of the present invention, a plurality of search regions are defined in a 3D medical image, corresponding to organs, bone structures, and search regions outside of organs and bones. The search regions may be defined based on anatomic landmarks, organs, and bone structures detected in the 3D medical image. Lesions are automatically detected in each search region using a trained region-specific lesion detector.

In another embodiment of the present invention, 3D medical image and corresponding clinical information are received. A trigger is detected in the clinical information and lesions are automatically detected in the 3D medical image in response to the detection of the trigger. Lesion detections results can then be stored and displayed.

In another embodiment of the present invention, lesions are automatically detected in a 3D medical image. The lesion detection results are automatically displayed and the detected lesions are automatically labeled. Filtering options can be displayed, and the lesions can be filtered based on a user selection of the filtering options. Lesions can be highlighted based on a comparison to previous lesion detection results.

These and other advantages of the invention will be apparent to those of ordinary skill in the art by reference to the following detailed description and the accompanying drawings.

### BRIEF DESCRIPTION OF THE DRAWINGS

FIG. 1 illustrates a method of automatically detecting lesions in a 3D medical image according to an embodiment of the present invention;

FIG. 2 illustrates hierarchical body parsing for region-specific lesion detection according to an embodiment of the present invention;

FIG. 3 illustrates specific search areas for lymph nodes that can be defined using anatomical landmarks;

FIG. 4 illustrates a method that provides a clinical workflow which integrates fully automatic lesion detection according to an embodiment of the present invention;

FIG. 5 illustrates an exemplary workflow diagram for implementing the clinical workflow of FIG. 4;

FIG. 6 illustrates a method for providing visualization and navigation of lesions detected in a 3D medical image according to an embodiment of the present invention;

FIG. 7 illustrates an exemplary interactive display for providing intelligent navigation of lesion detection results;

FIG. 8 illustrates displaying lesion detection results using a probability map; and

FIG. 9 is a high level block diagram of a computer capable of implementing the present invention.

### DETAILED DESCRIPTION

The present invention is directed to a method and system for automatic detection of lesions in 3D medical images, such as computed tomography (CT) and magnetic resonance (MR) images. A digital image is often composed of digital representations of one or more objects (or shapes). The digital representation of an object is often described herein in terms of identifying and manipulating the objects. Such manipulations are virtual manipulations accomplished in the memory or other circuitry/hardware of a computer system. Accordingly, it is to be understood that embodiments of the present invention may be performed within a computer system using data stored within the computer system.

Embodiments of the present invention provide methods for lesion detection and assessment in 3D medical image data, such as CT and MR data. The automatic lesion detection method described herein can be used to detect lesions in various parts of the body including, but not limited to, lymph nodes, organs such as the liver, spleen, and kidneys, other soft tissues such as in the abdominal cavity, and bone structures.

The automatic lesion detection method allows all lesions in the body to be detected and assessed quantitatively, since existing segmentation algorithms can be triggered automatically in response to the lesion detection results during a fully automatic pre-processing phase before the 3D image data is actually read by a user. This saves time and additionally, yields the total tumor burden (diameter or volume) and not just the burden of some selected target lesions. The detected lesions and associated segmentations allow for easy navigation through the lesions according to different criteria, such as lesion size (typically the largest lesions are of highest interest), lesion location (e.g., axillary, abdominal, etc.), and appearance (e.g., necrotic, fatty core, calcifications, etc.). Further, automatic detection reduces the dependency of reading results on the user and allows for a fully automatic comparison of follow up data to highlight changes in the detected lesions.

According to an embodiment of the present invention, a probabilistic framework is used for automatic lesion detection. In particular, a probabilistic framework can be sued for the detection of lesion-specific search regions and a probabilistic framework can be used for the detection of lesions within the search regions. According to another embodiment of the present invention a method is provided for a clinical workflow that integrates the automatic lesion detection. According to another embodiment of the present invention, a method is provided for visualization and navigation of the lesion detection results.

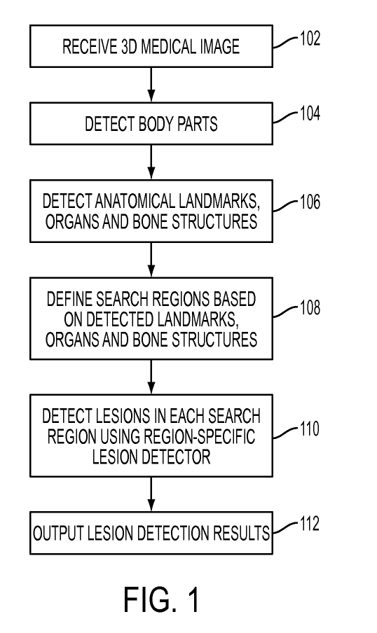

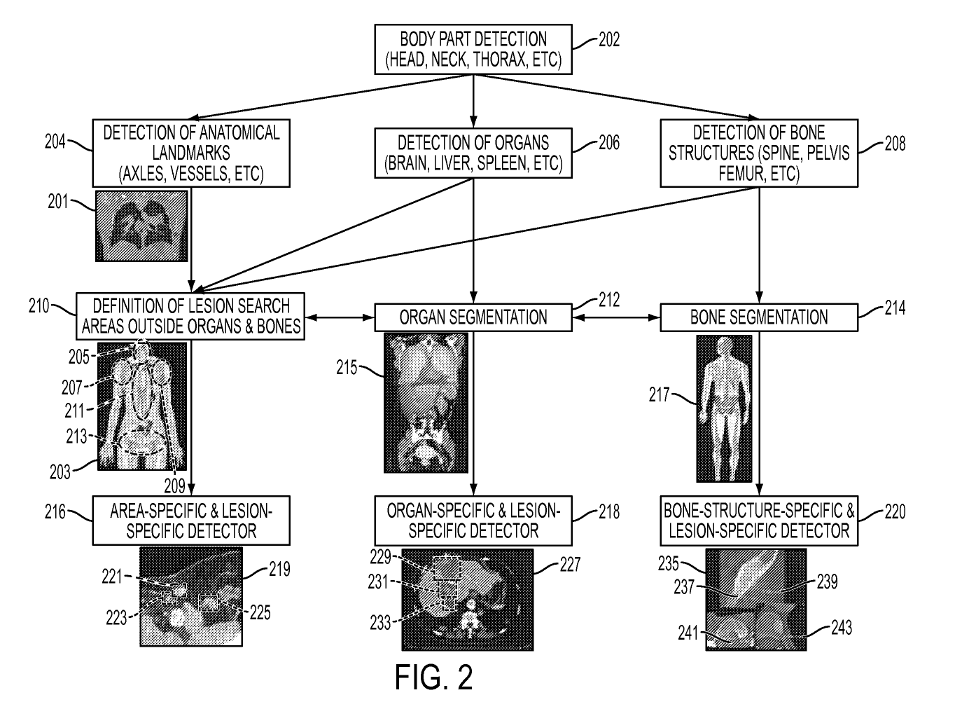

FIG. 1 illustrates a method of automatically detecting lesions in a 3D medical image according to an embodiment of the present invention. The method of FIG. 1 transforms medical image data representing anatomy of a patient in order to detect locations of lesions in the medical image data. Several lesion entities (e.g., liver, lung, kidney) are bound to specific organs and have a distinct appearance. However, some lesions, such as lymph node lesions and bone lesions, are not localized in the body and may appear at different locations. In addition, the appearance of the same lesion entity may differ between different body regions. For example, lymph nodes in the mediastinum look quite different from lymph nodes in the axillary regions. A general lesion detection algorithm for the whole body is therefore unlikely to yield reliable results. The method of FIG. 1 uses body-region-specific detectors that exploit the typical context of a given region to detect lesions. The definition of specific search regions is obtained by a hierarchical, fully-automatic parsing of body structures. The search regions for lesion detection are defined in a coarse-to-fine manner. FIG. 2 illustrates hierarchical body parsing for region-specific lesion detection according to an embodiment of the present invention. FIG. 2 provides additional detail for the method of FIG. 1, and therefore FIGS. 1 and 2 are described together.

Referring to FIG. 1, at step 102, a 3D medical image is received. The medical image can be a 3D medical image (volume) generated using an imaging modality, such as CT and MR. The medical image can also be a 3D medical image generated using a hybrid imaging modality, such as PET/CT and PET/MR. The medical image can be received directly from an image acquisition device (e.g., MR scanner, CT scanner, etc.). It is also possible that the medical image can be received by loading a medical image that was previously stored, for example on a memory or storage of a computer system or a computer readable medium.

At step 104, body parts are detected in the 3D medical image. For example, body parts such as the head, neck, thorax, etc., can be detected in the 3D medical image. The body part detection is shown at step 202 of FIG. 2. In order to detect the particular body parts in the 3D medical image, predetermined 2D slices of the medical image corresponding to the particular body parts can be detected. The predetermined slices can be detected using slice detectors trained based on annotated training data. For example, the slice detectors can be trained using a Probabilistic Boosting Tree (PBT) and 2D Haar features. The slice detectors can also be connected in a discriminative anatomical network (DAN), which ensures that the relative positions of the detected are correct. Detecting body parts by detecting slices in a 3D medical image is described in greater detail in United States Published Patent Application No. 2010/0080434, which is incorporated herein by reference.

At step 106, anatomical landmarks, organs, and bone structures are detected in the 3D medical image. Anatomical landmark detection is shown at step 204 of FIG. 2. The anatomical landmarks are landmarks that can be used to define search areas for lesions outside of organs and bone structures. The anatomical landmarks can include common locations for lymph nodes, such as the axillae, as well as various vessels and other anatomical landmarks. Image 201 shows exemplary anatomical landmark detection results. Organ detection is shown at step 206 of FIG. 2. Various organs, including but not limited to, the brain, liver, spleen, kidneys, lungs, heart, etc. can be detected. Bone structure segmentation is shown at step 208 of FIG. 2. Various bone structures including but not limited to, the spine, pelvis, femur, etc., can be detected. As shown in FIG. 2, the body part detection results are used in the anatomical landmark detection 204, the organ detection 206, and the bone structure detection 208. For example, a search space for detection of particular anatomic landmarks, organs, and bone structures using corresponding trained detectors may be constrained based on the body part detection results.

As described above, predetermined slices of the 3D medical image can be detected representing various body parts. The anatomic landmarks, organs (organ centers), and bone structures can then be detected in the 3D medical image using trained detectors (a specific detector trained for each individual landmark, organ, and bone structure) connected in a discriminative anatomical network (DAN). Each of the anatomic landmarks, organs, and bone structures can be detected in a portion of the 3D medical image constrained by at least one of the detected slices. A plurality of organs can then be segmented based on the detected anatomic landmarks and organ centers. Such a method for landmark and organ detection is described in greater detail in United States Published Patent Application No. 2010/0080434, which is incorporated herein by reference.

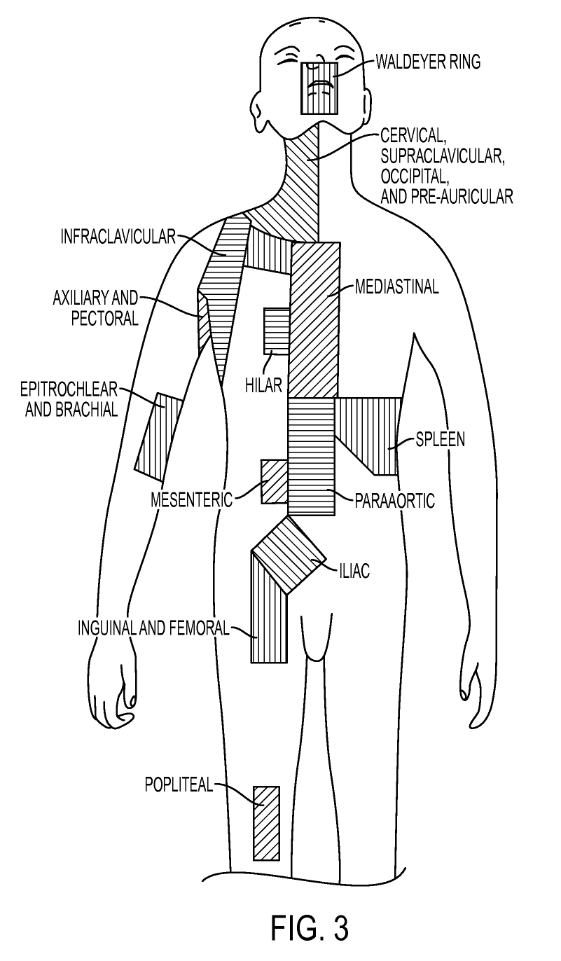

At step 108, search regions in the 3D medical image are defined based on the detected landmarks, organs, and bone structures. The detected anatomical landmarks are used to define search regions for lesions outside of organs and bones. FIG. 3 illustrates specific search areas for lymph nodes that can be defined using anatomical landmarks. In particular, FIG. 3 shows search regions defined based on anatomical landmarks for the following lymph node regions: Waldeyer ring; cervical, supraclavicular, occipital, and pre-auricular; infraclavicular; axillary and pectoral; mediastinal; hilar; epitrochlear and brachial; spleen; para-aortic; iliac; inguinal and femoral; and popliteal. Several landmarks may be used to define each region. For example, landmarks in the aorta may be used to define a cylindrical search region around the aorta for para-aortic lymph nodes, and landmarks in the pelvic bones may be used to define the search region for iliac lymph nodes. Returning to FIGS. 1 and 2, defining lesion search regions outside of organs and bones is shown at step 210. In addition to the detected anatomic landmarks, the detected organs and bone structures (as well as the segmented organs and bone structures) are also used to define the lesion search regions outside of organs and bones, in order to exclude the detected organs and bones from these search regions. Image 203 shows exemplary search areas 205, 207, 209, 211, and 213 defined based on detected anatomic landmarks, organs, and bone structures.

The search region is defined for each detected organ by segmenting the detected organ. Organ segmentation is shown at step 212 of FIG. 2. The detected organs can be segmented using well known organ segmentation techniques. According to a possible implementation, each detected organ can be segmented by detecting a position, orientation, and scale of the organ in the 3D medical image with corresponding trained organ detectors using Marginal Space Learning (MSL). The organ segmentation may take into account relationships between organs and/or between organs and other detected anatomical landmarks. Such a method for organ segmentation is described in greater detail in United States Published Patent Application No. 2010/0080434, which is incorporated herein by reference. Image 215 of FIG. 2 shows exemplary organ segmentation results.

The search region for each bone structure is defined by segmenting the detected bone structure. Bone segmentation is shown at step 214 of FIG. 2. The detected bone structures may be segmented using well known bone structure segmentation techniques. According to a possible implementation, each bone structure can be segmented by detecting a position, orientation, and scale of the structure in the 3D medical image with corresponding trained detectors using Marginal Space Learning (MSL). The bone structure segmentation may take into account relationships between the bone structure, organs and other detected anatomical landmarks. Such a method is similar to the organ segmentation, as described in United States Published Patent Application No. 2010/0080434, which is incorporated herein by reference. Image 217 of FIG. 2 shows exemplary bone segmentation results.

At step 110, lesions are detected in each of the search regions using a trained region-specific lesion detector. The problem of lesion localization (detection) is solved by first estimating the search regions parameterized by a set of parameters θ_{S} for a given volume V, and then using the information learned from the search region to detect the lesions P(θ_{L}|θ_{S},V) inside each search region. Here, θ_{L} denotes a set of parameters, such as position, rotation (orientation), and scale, that define a lesion and P(.) is the probability measure of the inferred parameters. The set of parameters can be further decomposed to marginal spaces. Probabilistic Boosting Trees (PBTs) can be used to learn these marginal probabilities based on training data. According to a possible implementation, marginal space learning (MSL) can be used to efficiently search hypotheses in this high dimensional space of parameters. In order to prevent too many lesion candidates from be located within a few dominant parameters, clustered marginal space learning (cMSL) can be used to detect and segment the lesions in each search region of the 3D medical image. cMSL reduces the number of candidates by clustering after MSL searches for best position candidates and scale candidates. Candidate-suppressed clustering can be used in order to avoid candidates of multiple lesions being clustered into one group. After MSL is applied to the restricted search space. cMSL is described in greater detail in Terrence Chen et al., “Automatic Follicle Quantification from 3D Ultrasound Data Using Global/Local Context with Database Guided Segmentation”, ICCV 2009.

As described above, cMSL can be used to detect lesions in each of the defined search regions. Accordingly, a separate region-specific detector is trained based on annotated training data for each region. Each region-specific detector is trained to search for lesions specific to the corresponding search region based on features extracted from the search region. Each region-specific detector can include multiple PBT classifiers corresponding which perform the MSL detection. Area-specific and lesion-specific lesion detection in the search areas outside organs and bones is shown at step 216 of FIG. 2. Image 219 shows lesions 221, 223, and 225 detected in an exemplary search area. Organ-specific and lesion-specific lesion detection is shown at step 218 of FIG. 2. Image 227 shows lesions 229, 231, and 233 detected in an exemplary segmented organ. Bone structure-specific and lesion-specific detection is shown at step 220 of FIG. 2. Image 235 shows lesions 237, 239, 241, and 243 detected in exemplary segmented bone structures.

At step 112, lesion detection results are output. The lesion detection results can be output by displaying the lesion detection results on a display of a computer system. For example, the detected and segmented lesions can be displayed in combination with the received 3D image data. It is also possible that the lesion detection results be displayed by displaying a probability map resulting from probability scores calculated by the lesion detectors. It is also possible to display a fused image resulting from combining the probability map with the medical image data. The lesion detection results can be displayed in an interactive display to provide intuitive navigation and assessment of the lesion detection results. Methods for visualizing and navigating lesion detection results are described in greater detail below.

The lesion detection results can also be output by storing the detection results, for example, on a memory or storage of a computer system or on a computer readable storage medium. The output lesion detection results can be also further processed. For example, the lesion detection results can be compared to previous lesion detection results for the same patient in order to detect whether the detected lesions have changed, new lesions have appeared, and/or previously detected lesions have disappeared.

Although the methods of FIGS. 1 and 2 have been described above as estimating search regions and detecting lesions using features extracted from a 3D medical image, it is to be understood that the above describe method can be extended to use features from hybrid imaging modalities, such as PET/CT and PET/MR. The information of two imaging modalities may further improve the accuracy and robustness of the detection.

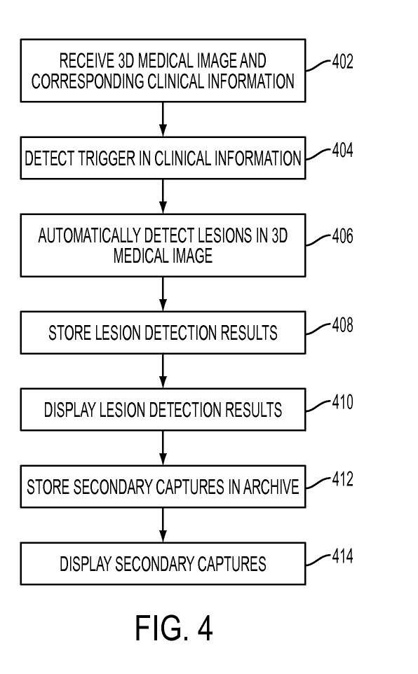

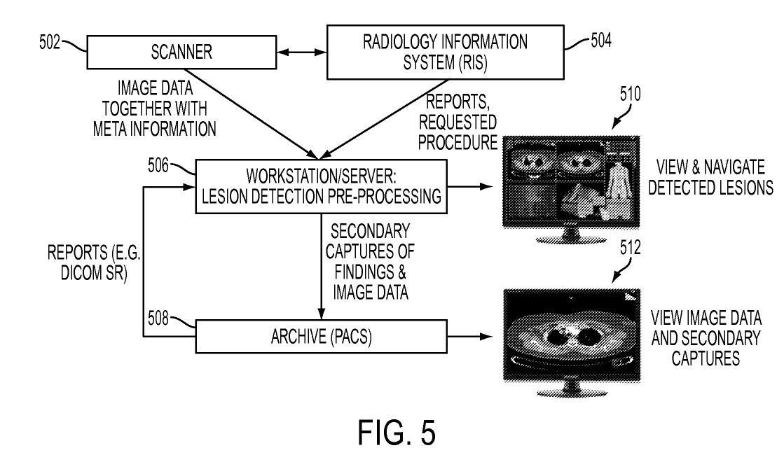

FIG. 4 illustrates a method that provides a clinical workflow which integrates fully automatic lesion detection according to an embodiment of the present invention. FIG. 5 illustrates an exemplary workflow diagram for implementing the clinical workflow of FIG. 4. According to an embodiment of the present invention, the fully automatic lesion detection method of FIGS. 1 and 2 can be integrated into a clinical workflow as a fully automatic pre-processing step that is executed before a users starts reads a scanned medical image. Referring to FIG. 4, at step 402, a 3D medical image and corresponding clinical information is received. In clinical routing, a scan to acquire a medical image is typically scheduled using a Radiology Information System (RIS). As illustrated in FIG. 5, image data is received at a workstation/server 506 from a scanner 502, which is in communication with RIS 504. Clinical information, such as the requested procedure, can be received at the workstation/server 506 from RIS 504. The clinical information can also be extracted from existing clinical reports of the patient, e.g. from prior cancer follow-up scans. These reports are usually stored in the RIS but can also be stored in the PACS 508 (e.g., in the case of DICOM Structured Reports (DICOM SR)) and received at the workstation/server 506 from the PACS 508. At step 404, a trigger is detected in the clinical information. The trigger may detected by detecting a predetermined word or phrase in the clinical information. For example, the trigger may be detected if the clinical information indicates that a particular type of procedure is requested. The trigger may be detected from the clinical reports by detecting any cancer-related key word in the report. This may be based on the usage of well-known semantic knowledge models (Ontologies) such as the International Classification of Disease (ICD).

At step 406, lesions are automatically detected in the 3D medical image in response to detection of the trigger. Upon arrival of new image data at the workstation/server 506, the fully automatic lesion detection pre-processing of the image data is triggered on the workstation/server 506 by exploiting the available RIS information, such as the requested procedure (e.g., “Abdomen tumor follow up staging”). The lesions can be automatically detected in the 3D medical image using the method of FIGS. 1 and 2 described above. At step 408, lesion detection results are stored. For example, in FIG. 5, the lesion detection results can be stored on a memory or storage of the workstation/server 506 or sent to archive 508. At 410, the lesion detection results are displayed. As illustrated in FIG. 5, the lesion detection results are displayed by display device 510, such that the detected lesions can be viewed and navigated. At step 412, secondary captures, or screenshots, of the detected lesions are stored in an archive, and at step 414, the secondary captures are displayed. In FIG. 5, secondary captures and image data are stored on archive 508, which may be a picture archiving and communications system (PACS). The image data and secondary captures can then be displayed on display device 512.

It is to be understood that the framework for the clinical workflow described above may also be used as a screening tool for lesions on image data that was acquired based on a different clinical indication than cancer.

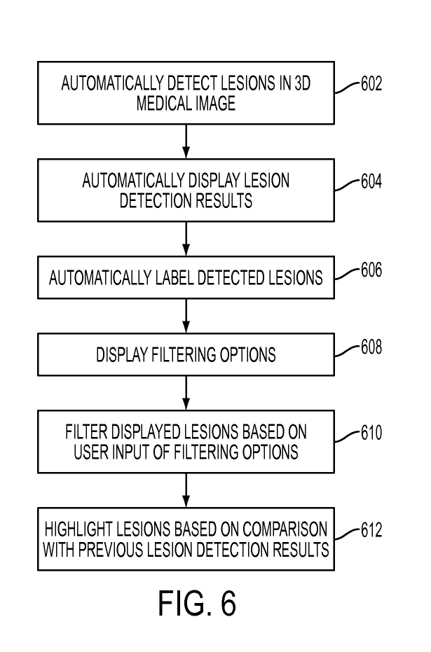

FIG. 6 illustrates a method for providing visualization and navigation of lesions detected in a 3D medical image according to an embodiment of the present invention. As illustrated in FIG. 6, at step 602, lesions are automatically detected in a 3D medical image. The lesions can be automatically detected in the 3D medical image using the method of FIGS. 1 and 2 described above.

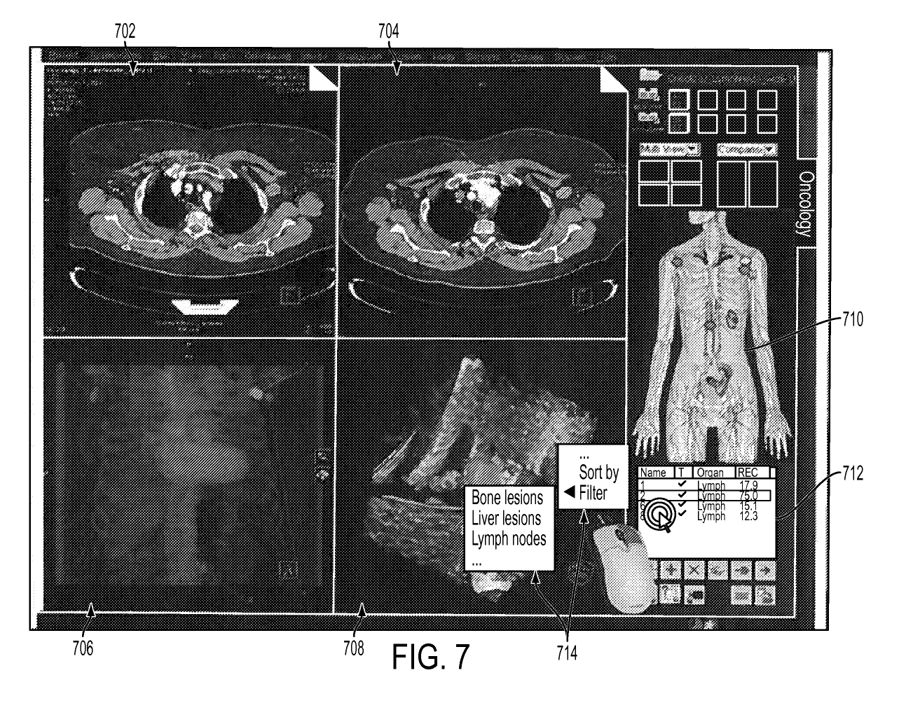

At step 604, lesion detection results are automatically displayed. The lesion detection results can be displayed in an interactive display to provide intelligent navigation and assessment of the lesion detection results. For example, lesion detection results can be displayed on an interactive pictogram, as a list of findings, within a 3D rendering of the image data, and/or as a graphical overlay of the original image data. FIG. 7 illustrates an exemplary interactive display for providing intelligent navigation of lesion detection results. As illustrated in FIG. 7, the interactive display 700 displays detected lesions in various slices 702 and 704 of the medical image data, a 3D rendering 706 of the image data, a zoomed-in portion 708, and in corresponding locations in a 3D model of a body 710. The interactive display 700 also displays the detected lesions as a list of findings 712.

Returning to FIG. 6, at step 606, the detected lesions are automatically labeled. For example, the detected lesions can be labeled with: lesion entity (e.g., liver, lymph node, bone, etc.), parent anatomical structure (e.g., mediatinum, neck, etc.), or other labels, such as calcified, fatty core (lymph nodes), etc., which can also be determined based on the learning-based lesion detectors. As illustrated in FIG. 7, the lesions in list 712 are labeled as “lymph node”.

Returning to FIG. 6, at step 608, filtering options are displayed, and at step 610, the displayed lesion detection results are filtered based on a user input of the filtering options. The filtering options allow a user to filter (hide or show) and sort findings according to different criteria, such as lesion entity (e.g., “show only liver lesions”) and estimated size (e.g., “show all lesions larger than xx mm). As shown in FIG. 7, the interactive display 700 includes filtering options 714 to allow a user to filter the detected lesions. The interactive display 700 can also provide a user with an option to accept, refine, or reject detected lesions.

Returning to FIG. 6, at step 612, lesions are highlighted based on a comparison with previous lesion detection results. Accordingly, an interactive display may also be used in a follow-up scenario in which the current tumor burden is compared to one or more prior exams. Using image registration algorithms, corresponding lesions in prior and follow-up scans can be identified. In this case, new lesions that were not previously detected can be highlighted, e.g., using a specific color. It is also possible that lesions in a previous scan that have disappears can be highlighted. It is also possible that lesions that changed (e.g., grew or shrank) may be highlighted. For example, different color schemes can be used to indicate the degree of growth or shrinkage.

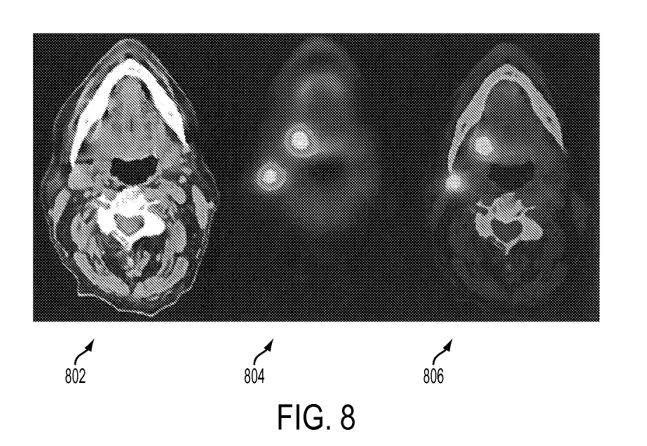

In addition to the display of detected lesion candidates, a “fuzzy” method of result visualization may be used. As described above, the probabilistic detection framework also outputs a probability map of each image voxel belonging to a given lesion entity. This probability map can be displayed similar to the display of PET/CT data. Augmenting morphological CT information, PET data displays metabolic activity of body regions where tumors usually stand out as areas with high image intensity. According to an embodiment of the present invention, the probability map can be displayed in a similar fashion to PET data. FIG. 8 illustrates displaying lesion detection results using a probability map. Image 802 of FIG. 8 shows a display of CT image data. As illustrated in FIG. 8, image 804 shows a probability map displayed alone and image 806 shows a probability map in a fused mode, overlaid on morphological image data. It is to be understood that the same display options may also be presented in 3D renderings. This “fuzzy” form of displaying the lesion detection results allows clinicians who are used to viewing similar image to interpret the probability map similar to PET functional measurements. Also, this visualization mode may ease regulatory clearance of the above described region detection framework by highlighting suspicious, lesion-like structures.

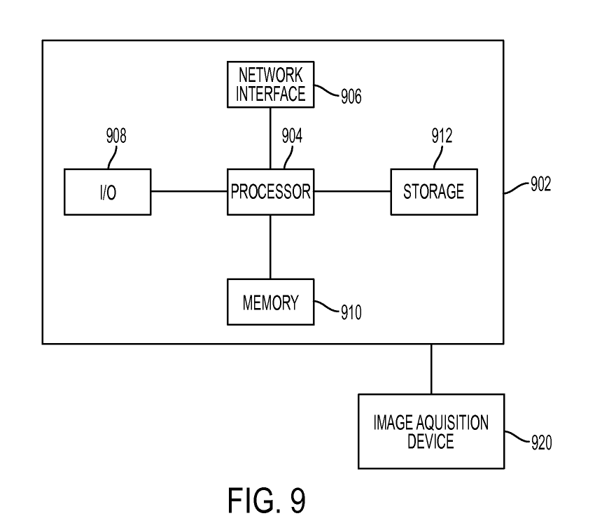

The above-described methods for automatic lesion detection, a clinical workflow integrating automatic lesion detection, and visualizing lesion detection results may be implemented on a computer using well-known computer processors, memory units, storage devices, computer software, and other components. A high level block diagram of such a computer is illustrated in FIG. 9. Computer 902 contains a processor 904 which controls the overall operation of the computer 902 by executing computer program instructions which define such operations. The computer program instructions may be stored in a storage device 912, or other computer readable medium (e.g., magnetic disk, CD ROM, etc.) and loaded into memory 910 when execution of the computer program instructions is desired. Thus, the steps of the methods of FIGS. 1, 2, 4, and 6 may be defined by the computer program instructions stored in the memory 910 and/or storage 912 and controlled by the processor 904 executing the computer program instructions. An image acquisition device 920, such as an MR scanning device or a CT scanning device, can be connected to the computer 902 to input medical images to the computer 902. It is possible to implement the image acquisition device 920 and the computer 902 as one device. It is also possible that the image acquisition device 920 and the computer 902 communicate wirelessly through a network. The computer 902 also includes one or more network interfaces 906 for communicating with other devices via a network. The computer 902 also includes other input/output devices 908 that enable user interaction with the computer 902 (e.g., display, keyboard, mouse, speakers, buttons, etc.). One skilled in the art will recognize that an implementation of an actual computer could contain other components as well, and that FIG. 9 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for detecting lesions in a 3D medical image, comprising:
defining a plurality of search regions in the 3D medical image based on anatomic landmarks, organs, and bone structures in the 3D medical image; and
detecting lesions in each of the plurality of search regions using a trained region-specific lesion detector.

2. The method of claim 1, further comprising:
detecting the anatomic landmarks, organs, and bone structures in the 3D medical image;

3. The method of claim 2, wherein said step of detecting the anatomic landmarks, organs, and bone structures in the 3D medical image comprises:
detecting a plurality of body parts in the 3D medical image; and
detecting the anatomic landmarks, organs, and bone structures in the 3D medical image based on the detected body parts in the 3D medical image.

4. The method of claim 3, wherein said step of detecting a plurality of body parts in the 3D medical image comprises:
detecting predetermined slices of the 3D medical image corresponding to the body parts.

5. The method of claim 4, wherein said step of detecting the anatomic landmarks, organs, and bone structures in the 3D medical image based on the detected body parts in the 3D medical image comprises:
detecting the anatomic landmarks, organs, and bone structures using a separate trained detector for each of the anatomic landmarks, organs, and bone structures, wherein each trained detector is constrained based on at least one of the predetermined slices.

6. The method of claim 1, wherein said step of defining a plurality of search regions in the 3D medical image based on anatomic landmarks, organs, and bone structures in the 3D medical image comprises:
defining at least one organ search region in the 3D medical image by segmenting at least one organ in the 3D medical image;
defining at least one bone structure search region in the 3D medical image by segmenting at least one bone structure in the 3D medical image; and
defining at least one search region outside of organs and bone structures based on a location of at least one anatomic landmark;

7. The method of claim 6, wherein said step of defining at least one search region outside of organs and bone structures based on a location of at least one anatomic landmark comprises:
excluding regions from said at least one search region outside of organs and bone structures based on the organs and the bone structures in the 3D medical image.

8. The method of claim 1, wherein said step of detecting lesions in each of the plurality of search regions using a trained region-specific lesion detector comprises:
detecting lesions by each trained region-specific lesion detector based on features extracted from the repective one of the plurality of search regions.

9. The method of claim 8, wherein said step of detecting lesions by each trained region-specific lesion detector based on features extracted from the repective one of the plurality of search regions comprises:
detecting lesions by each trained region-specific lesion detector based on features extracted from the repective one of the plurality of search regions using clustered marginal space learning.

10. The method of claim 1, wherein each trained region-specific lesion detector is trained based on training data using a Probabilistic Boosting Tree (PBT).

11. An apparatus for detecting lesions in a 3D medical image, comprising:
means for defining a plurality of search regions in the 3D medical image based on anatomic landmarks, organs, and bone structures in the 3D medical image; and
means for detecting lesions in each of the plurality of search regions using a trained region-specific lesion detector.

12. The apparatus of claim 11, further comprising:
means for detecting the anatomic landmarks, organs, and bone structures in the 3D medical image;

13. The apparatus of claim 12, wherein said means for detecting the anatomic landmarks, organs, and bone structures in the 3D medical image comprises:
means for detecting a plurality of body parts in the 3D medical image; and
means for detecting the anatomic landmarks, organs, and bone structures in the 3D medical image based on the detected body parts in the 3D medical image.

14. The apparatus of claim 11, wherein said means for defining a plurality of search regions in the 3D medical image based on anatomic landmarks, organs, and bone structures in the 3D medical image comprises:
means for defining at least one organ search region in the 3D medical image by segmenting at least one organ in the 3D medical image;
means for defining at least one bone structure search region in the 3D medical image by segmenting at least one bone structure in the 3D medical image; and
means for defining at least one search region outside of organs and bone structures based on a location of at least one anatomic landmark;

15. The apparatus of claim 11, wherein said means for detecting lesions in each of the plurality of search regions using a trained region-specific lesion detector comprises:
means for detecting lesions by each trained region-specific lesion detector based on features extracted from the repective one of the plurality of search regions.

16. The apparatus of claim 15, wherein said means for detecting lesions by each trained region-specific lesion detector based on features extracted from the repective one of the plurality of search regions comprises:
means for detecting lesions by each trained region-specific lesion detector based on features extracted from the repective one of the plurality of search regions using clustered marginal space learning.

17. A non-transitory computer readable medium encoded with computer executable instructions for detecting lesions in a 3D medical image, the computer executable instructions defining steps comprising:
defining a plurality of search regions in the 3D medical image based on anatomic landmarks, organs, and bone structures in the 3D medical image; and
detecting lesions in each of the plurality of search regions using a trained region-specific lesion detector.

18. The computer readable medium of claim 17, further comprising computer executable instructions defining the step of:
detecting the anatomic landmarks, organs, and bone structures in the 3D medical image;

19. The computer readable medium of claim 18, wherein the computer executable instructions defining the step of detecting the anatomic landmarks, organs, and bone structures in the 3D medical image comprise computer executable instructions defining the steps of:
detecting a plurality of body parts in the 3D medical image; and
detecting the anatomic landmarks, organs, and bone structures in the 3D medical image based on the detected body parts in the 3D medical image.

20. The computer readable medium of claim 17, wherein the computer executable instructions defining the step of defining a plurality of search regions in the 3D medical image based on anatomic landmarks, organs, and bone structures in the 3D medical image comprise computer executable instructions defining the steps of:
defining at least one organ search region in the 3D medical image by segmenting at least one organ in the 3D medical image;
defining at least one bone structure search region in the 3D medical image by segmenting at least one bone structure in the 3D medical image; and
defining at least one search region outside of organs and bone structures based on a location of at least one anatomic landmark;

21. The computer readable medium of claim 17, wherein the computer executable instructions defining the step of detecting lesions in each of the plurality of search regions using a trained region-specific lesion detector comprise computer executable instructions defining the step of:
detecting lesions by each trained region-specific lesion detector based on features extracted from the repective one of the plurality of search regions.

22. The computer readable medium of claim 21, wherein the computer executable instructions defining the step of detecting lesions by each trained region-specific lesion detector based on features extracted from the repective one of the plurality of search regions comprise computer executable instructions defining the step of:
detecting lesions by each trained region-specific lesion detector based on features extracted from the repective one of the plurality of search regions using clustered marginal space learning.

23. A method of processing a medical image data, comprising:
receiving a 3D medical image and corresponding clinical information;
detecting a trigger in the clinical information; and
automatically detecting lesions in the 3D medical image in response to detecting the trigger in the clinical information.

24. The method of claim 23, wherein the clinical information is Radiology Information System Information (RIS).

25. The method of claim 23, wherein the clinical information is extracted from existing clinical reports of a patient.

26. The method of claim 25, wherein said step of detecting a trigger in the clinical information comprises:
detecting a cancer-related keyword in the clinical reports.

27. The method of claim 23, wherein said step of detecting a trigger in the clinical information comprises:
detecting a certain type of requested procedure in the clinical information.

28. A method of visualizing lesions in a 3D medical image, comprising:
automatically detecting lesions in a 3D medical image;
automatically displaying the detected lesions in an interactive display; and
automatically labeling displayed lesions.

29. The method of claim 28, wherein said step of automatically displaying the detected lesions in an interactive display comprises:
displaying the detected lesions as a probability map based on probabilities output by detectors used to detect the lesion in the 3D medical image.

30. The method of claim 29, wherein said step of displaying the detected lesions as a probability map based on probabilities output by detectors used to detect the lesion in the 3D medical image comprises:
displaying a fused image of the probability map and the 3D medical image.

31. The method of claim 28, further comprising:
displaying filtering options; and
filtering the displayed lesions based on a user input of the filtering options.

32. The method of claim 28, further comprising:
highlighting lesions based on a comparison of the detected lesions with previously detected lesions.

33. The method of claim 32 wherein said step of highlighting lesions based on a comparison of the detected lesions with previously detected lesions comprises at least one of:
highlighting new lesions that were not detected in the previously detected lesions;
highlighting lesions in the previously detected lesions that are not detected in detected lesions; and
highlighting lesions that have changed in the detected lesions from the previously detected lesions.
